(19) United States
(12) Patent Application Publication
(10) Pub. No.: US 2010/0163798 A1
(43) Pub. Date: Jul. 1, 2010

(54) SEMICONDUCTOR NANOPARTICLE PHOSPHOR INCLUDING NANOPARTICLE CORE COMPOSED OF GROUP-XIII AND -XV SEMICONDUCTOR AND FIRST SHELL AND SECOND SHELL FOR COATING THE SAME

(76) Inventors: Tatsuya Ryowa, Osaka (JP); Junichi Kinomoto, Osaka (JP)

Correspondence Address: BIRCH STEWART KOLASCH & BIRCH, PO BOX 747, FALLS CHURCH, VA, 22040-0747, US

(21) Appl. No.: 12/624,095

(22) Filed: Nov. 23, 2009

(30) Foreign Application Priority Data
Dec. 26, 2008 (JP) 2008-333303(P)

(51) Int. Cl. C09K 11/62

(52) U.S. Cl. 252/301.4 R; 977/773

(57) ABSTRACT

A semiconductor nanoparticle phosphor includes a nanoparticle core composed of a group-XIII and -XV semiconductor, a first shell for coating the nanoparticle core, and a second shell for coating the first shell, a difference in a lattice constant between the nanoparticle core and the second shell being smaller than a difference in the lattice constant between the nanoparticle core and the first shell, or the first shell being smaller in the lattice constant than the nanoparticle core and the second shell being greater in the lattice constant than the nanoparticle core, or the first shell being greater in the lattice constant than the nanoparticle core and the second shell being smaller in the lattice constant than the nanoparticle core.

This nonprovisional application is based on Japanese Patent Application No. 2008-333303 filed with the Japan Patent Office on Dec. 26, 2008, the entire contents of which are hereby incorporated by reference.

### FIELD OF THE INVENTION

The present invention relates to a semiconductor nanoparticle phosphor, and more specifically to a semiconductor nanoparticle phosphor including a stack structure achieving improved emission intensity and light emission efficiency.

### DESCRIPTION OF THE BACKGROUND ART

It has been known that a quantum size effect is exhibited as a particle size of a semiconductor crystal particle (hereinafter referred to as “crystal particle”) is made as small as an exciton Bohr radius. Here, the quantum size effect is such that, when a particle size of a crystal particle is made smaller, electrons therein can no longer freely move and energy of the electrons can only have a specific value. For example, as the particle size of the semiconductor crystal particle is made smaller, light generated from the semiconductor crystal particle has a shorter wavelength (see C. B. Murray et al., (Journal of the American Chemical Society), 1993, 115, pp. 8706 to 8715 (Non-Patent Document 1)). Non-Patent Document 1 describes use of a group-II and -VI compound semiconductor for semiconductor crystal particles. The semiconductor crystal particles composed of the group-II and -VI compound semiconductor are disadvantageous in reliability and durability. In addition, the group-II and -VI compound semiconductor contains an environmental pollutant such as cadmium or selenium, and it has been desired to fabricate semiconductor crystal particles with a material replacing such an environmental pollutant.

Japanese Patent Laying-Open No. 2004-307679 (Patent Document 1) aims to fabricate semiconductor crystal particles with microcrystals of a nitride-based semiconductor as a material replacing the group-II and -VI compound semiconductor. Patent Document 1 discloses a group-XIII nitride semiconductor nanoparticle phosphor having such a structure that a core is coated with a shell (hereinafter also denoted as a “core shell structure”). Disclosure in Patent Document 1 will more specifically be described. By coating a core with a compound having higher band gap energy, the energy state at a surface of the semiconductor nanoparticles can be stabilized and hence light emission efficiency of the semiconductor crystal particles can be improved. The group-XIII nitride semiconductor nanoparticles having the core shell structure, however, suffer from generation or a large number of crystal defects due to lattice mismatch between the core and the shell as well as irregularities in the surface of the core and the shell, which leads to significantly low crystallinity of the core and the shell and lower light emission efficiency of the semiconductor nanoparticles.

The present invention was made in view of the circumstances as above, and the feature of the present invention resides in forming a two-layered shell on a surface of a core in order to relax lattice mismatch caused between the core and the shell in the core shell structure. The present invention aims to improve crystallinity of semiconductor nanoparticles to cap a surface defect by forming the two-layered shell. In addition, the present invention aims to provide a semiconductor nanoparticle phosphor achieving high dispersiveness and high light emission efficiency as well as excellent reliability by firmly bonding modifying organic molecules to the surface of the semiconductor nanoparticles.

### SUMMARY OF THE INVENTION

A semiconductor nanoparticle phosphor according to the present invention includes a nanoparticle core composed of a group-XIII and -XV semiconductor, a first shell for coating the nanoparticle core, and a second shell for coating the first shell. A difference in a lattice constant between the nanoparticle core and the second shell is smaller than a difference in the lattice constant between the nanoparticle core and the first shell, or the first shell is smaller in the lattice constant than the nanoparticle core and the second shell is greater in the lattice constant than the nanoparticle core, or the first shell is greater in the lattice constant than the nanoparticle core and the second shell is smaller in the lattice constant than the nanoparticle core.

In addition, preferably, the respective lattice constants of the nanoparticle core, the first shell and the second shell satisfy relation, in terms of magnitude, of the first shell < the nanoparticle core < the second shell, or the second shell < the nanoparticle core < the first shell.

In addition, preferably, the respective lattice constants of the nanoparticle core, the first shell and the second shell satisfy relation, in terms of magnitude, of the nanoparticle core < the second shell < the first shell, or the first shell < the second shell < the nanoparticle core.

In addition, preferably, the nanoparticle core is made of a group-XIII nitride semiconductor.

In addition, preferably, the nanoparticle core is made of indium nitride.

In addition, preferably, the nanoparticle core is made of a group-XIII mixed crystal nitride semiconductor.

In addition, preferably, the nanoparticle core is made of indium gallium nitride.

In addition, preferably, the nanoparticle core has an average particle size not greater than twice as large as a Bohr radius.

In addition, preferably, the semiconductor nanoparticle phosphor further includes a plurality of shells on an outer side of the second shell, and has a stack structure including three or more layers from the first shell to an outermost shell.

In addition, preferably, an outer surface of the second shell or the outermost shell is bonded to or coated with a modifying organic molecule.

The semiconductor nanoparticle phosphor according to the present invention has the second shell having a controlled lattice constant. The second shell can suppress generation of crystal defects caused by lattice mismatch between the group-XIII and -XV semiconductor nanoparticle core and the first shell. Therefore, light emission efficiency of the semiconductor nanoparticle phosphor can be enhanced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an exemplary structure of a semiconductor nanoparticle phosphor according to the present invention.

FIG. 2 is a schematic diagram of a phosphor manufactured in Comparative Example 1.

FIG. 3 is a diagram showing light emission characteristics of the semiconductor nanoparticle phosphors in Example 1 and Comparative Example 1.

### DESCRIPTION OF THE PREFERRED EMBODIMENTS

An embodiment of the present invention will be described hereinafter with reference to the drawings. In the drawings below, the same or corresponding elements have the same reference characters allotted, and description thereof will not be repeated. In addition, dimensional relation such as length, size and width in the drawings is modified as appropriate for clarity and simplification of the drawings, and actual dimensions are not shown.

<Basic Structure of Semiconductor Nanoparticle Phosphor>

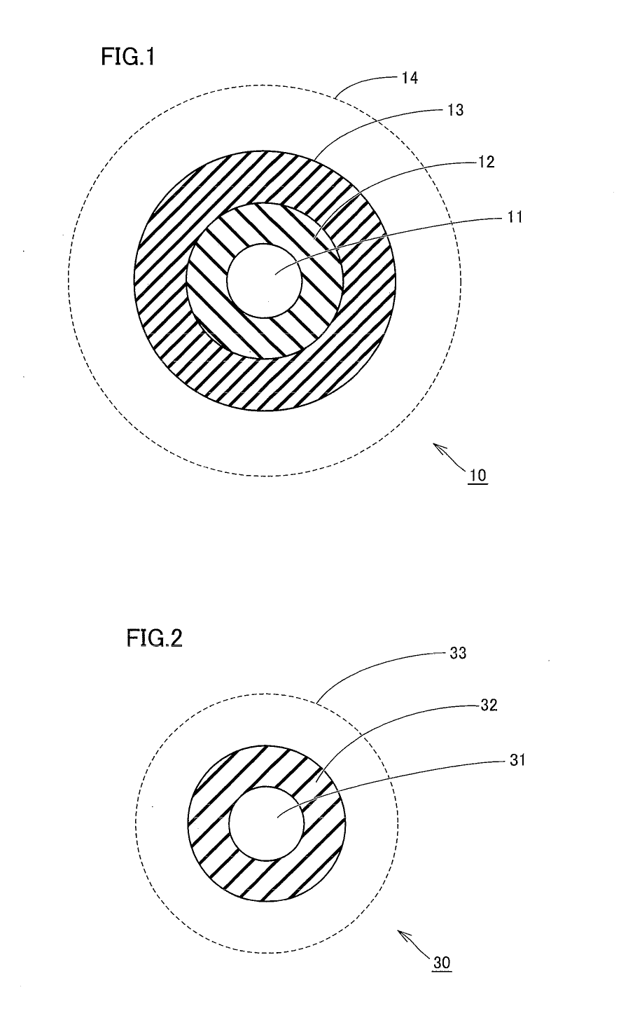

FIG. 1 is a schematic diagram showing an exemplary structure of a semiconductor nanoparticle phosphor according to the present invention. Description will be given hereinafter with reference to FIG. 1.

A semiconductor nanoparticle phosphor 10 according to the present invention includes a nanoparticle core 11 composed of a group-XIII and -XV semiconductor, a first shell 12 for coating nanoparticle core 11, and a second shell 13 for coating first shell 12. Namely, semiconductor nanoparticle phosphor 10 according to the present invention has a stack structure of three layers of nanoparticle core 11, first shell 12 and second shell 13. A surface of second shell 13 is coated with a modifying organic molecule 14. The surface of second shell 13 is coated with modifying organic molecule 14 through two types of bonding of such chemical bonding as coordinate bonding of heteroatoms and physical adsorption bonding. Nanoparticle core 11 is partially or entirely coated with first shell 12. First shell 12 and second shell 13 may not be uniform in thickness, and they may include a large thickness portion and a small thickness portion. First shell 12 is formed, coming under the influence of a crystal structure of nanoparticle core 11. Nanoparticle core 11 and first shell 12 are chemically bonded to each other. In addition, second shell 13 is formed, coming under the influence of a crystal structure of first shell 12. First shell 12 and the second shell are chemically bonded to each other.

Here, nanoparticle core 11 serves as a core of growth during crystal growth of first shell 12. On the surface of nanoparticle core 11, a group-XV element and a group-XIII element having dangling bonds are arranged. An element serving as a raw material for first shell 12 is bonded to the elements having these dangling bonds.

When first shell 12 is greater in the lattice constant than nanoparticle core 11, tensile stress is applied to nanoparticle core 11 from first shell 12. On the other hand, when first shell 12 is smaller in the lattice constant than nanoparticle core 11, compressive stress is applied to nanoparticle core 11 from first shell 12.

When tensile or compressive stress is applied to nanoparticle core 11, crystal lattice of nanoparticle core 11 and first shell 12 is strained. In order to relax strain of the crystal lattice, defects are produced in crystals of nanoparticle core 11 and first shell 12.

Then, by growing second shell 13 on an outer side of first shell 12, compressive or tensile stress applied to nanoparticle core 11 from first shell 12 is relaxed and hence lattice mismatch of nanoparticle core 11 can be suppressed. Namely, for example, when tensile stress is applied to nanoparticle core 11 from first shell 12, second shell 13 smaller in the lattice constant than nanoparticle core 11 is preferably grown. Since compressive stress is produced in nanoparticle core 11 as a result of formation of second shell 13, lattice mismatch of nanoparticle core 11 can be suppressed. On the other hand, when compressive stress is applied to nanoparticle core 11 from first shell 12, second shell 13 greater in the lattice constant than nanoparticle core 11 is preferably grown. Since tensile stress is produced in nanoparticle core 11 as a result of formation of second shell 13, lattice mismatch of nanoparticle core 11 can be suppressed.

In addition, when tensile stress is applied to nanoparticle core 11 from first shell 12, tensile stress applied to nanoparticle core 11 from first shell 12 can be relaxed provided that the lattice constant of second shell 13 is intermediate between the lattice constant of nanoparticle core 11 and the lattice constant of first shell 12. Similarly, when compressive stress is applied to nanoparticle core 11 from first shell 12 as well, compressive stress applied to nanoparticle core 11 from first shell 12 can be relaxed provided that the lattice constant of second shell 13 is intermediate between the lattice constant of nanoparticle core 11 and the lattice constant of first shell 12.

From the foregoing, according to the present invention, any of (1) to (3) below is required.

(1) The difference in the lattice constant between the nanoparticle core and the second shell is smaller than the difference in the lattice constant between the nanoparticle core and the first shell.

(2) The first shell is smaller in the lattice constant than the nanoparticle core and the second shell is greater in the lattice constant than the nanoparticle core.

(3) The first shell is greater in the lattice constant than the nanoparticle core and the second shell is smaller in the lattice constant than the nanoparticle core.

This is because, as stress is applied to the first shell from the second shell, stress from the first shell to the nanoparticle core is relaxed and hence generation of defects originating from the difference in the lattice constant between the nanoparticle core and the first shell is suppressed.

When the respective lattice constants of nanoparticle core 11, first shell 12 and second shell 13 satisfy relation, in terms of magnitude, of the first shell < the nanoparticle core < the second shell, or the second shell < the nanoparticle core < the first shell, compressive or tensile stress applied to nanoparticle core 11 from first shell 12 can particularly be relaxed.

In addition, for the reasons similar to the above, when the respective lattice constants of nanoparticle core 11, first shell 12 and second shell 13 satisfy relation, in terms of magnitude, of the nanoparticle core < the second shell < the first shell, or the first shell < the second shell < the nanoparticle core, compressive or tensile stress applied to nanoparticle core 11 from first shell 12 can particularly be relaxed.

Moreover, in the present embodiment, the lattice constant can be determined by observing a lattice image by using a TEM (transmission electron microscope).

When semiconductor nanoparticle phosphor 10 is irradiated with excitation light, energy of the excitation light is absorbed by nanoparticle core 11. The excitation light absorbed by nanoparticle core 11 makes transition between a ground level of a conduction band and a ground level of a valence band, and light having a wavelength corresponding to that energy is emitted. First shell 12 and second shell 13 contribute to an effect of confining excitation carriers generated in nanoparticle core 11 composed of the group-XIII and -XV semiconductor, to thereby improve light emission efficiency. In the present invention, as an average particle size of nanoparticle core 11 is small to such an extent as having the quantum size effect, nanoparticle core 11 can have a plurality of dispersed energy levels, or it may have one level.

In addition, an average particle size of semiconductor nanoparticle phosphor 10 is normally estimated to be 2 to 6 nm, based on a result of a spectrum half width in X-ray diffraction measurement. This phosphor means a microparticle not greater than twice as large as an exciton Bohr radius. The average particle size of semiconductor nanoparticle phosphor 10 is preferably in a range from 0.1 nm to 100 nm, more preferably in a range from 0.5 nm to 50 nm, and further preferably in a range from 1 to 20 nm.

First shell 12 and second shell 13 have a thickness preferably from 0.1 to 10 nm. Here, when first shell 12 and second shell 13 have a thickness smaller than 0.1 nm, it is difficult to sufficiently coat the surface of nanoparticle core 11. On the other hand, when first shell 12 and second shell 13 have a thickness larger than 10 nm, it is difficult to uniformly form the shell and defects increase, which is not preferred. In addition, a thickness of first shell 12 and second shell 13 larger than 10 nm is not desirable also in terms of cost for the raw material.

The thickness of first shell 12, second shell 13 and modifying organic molecule 14 in semiconductor nanoparticle phosphor 10 according to the present invention can be known by observing a lattice image under high magnification by using a TEM.

In the present embodiment, nanoparticle core 11 is formed by a nanoparticle made of a semiconductor. Nanoparticle core 11 is formed of a group-XIII and -XV semiconductor obtained by bonding between a group-XIII element (B, Al, Ga, In, Tl) and a group-XV element (N, P, As, Sb, Bi). Nanoparticle core 11 is preferably made of a semiconductor having a composition having band gap achieving emission of visible light, that is, any of InN, InP, InGaN, InGaP, AlInN, AlInP, AlGaInN, and AlGaInP. By controlling a particle size and a mixed crystal ratio by using such a material, intended visible light can be emitted.

The band gap of nanoparticle core 11 is preferably in a range from 1.8 to 2.8 eV. When semiconductor nanoparticle phosphor 10 is used as a red phosphor, the band gap of nanoparticle core 11 is preferably from 1.85 to 2.5 eV. Alternatively, when semiconductor nanoparticle phosphor 10 is used as a green phosphor, the band gap of nanoparticle core 11 is preferably from 2.3 to 2.5 eV. When semiconductor nanoparticle phosphor 10 is used as a blue phosphor, the band gap of nanoparticle core 11 is particularly preferably in a range from 2.65 to 2.8 eV. By adjusting the average particle size of nanoparticle core 11 composed of the group-XIII and -XV semiconductor and the mixed crystal ratio of a group-XIII metal, a color of light emission from semiconductor nanoparticle phosphor 10 can be determined. Therefore, nanoparticle core 11 is preferably composed of a group-XIII mixed crystal nitride semiconductor.

When nanoparticle core 11 has the average particle size not greater than twice as large as an exciton Bohr radius, emission intensity is remarkably improved. The Bohr radius represents spread of probability of presence of excitons and it is expressed in Equation (1). For example, the exciton Bohr radius of GaN is approximately 3 nm and the exciton Bohr radius of InN is approximately 7 nm.

y=4πεh²·me² Equation (1)

where y represents a Bohr radius, ε represents permittivity, h represents a Planck constant, m represents an effective mass, and e represents an elementary quantity of charges.

When semiconductor nanoparticle phosphor 10 has the average particle size not greater than twice as large as the exciton Bohr radius, optical band gap becomes wider as a result of the quantum size effect. Even in such a case, the band gap is preferably in the range described above.

In addition, first shell 12 is formed on the surface of nanoparticle core 11, coming under the influence of the crystal structure of nanoparticle core 11. First shell 12 is preferably composed of any of GaAs, GaP, GaN, GaSb, InAs, InP, InN, InSb, AlAs, AlP, AlSb, MN, ZnO, ZnS, ZnSe, and ZnTe.

Moreover, second shell 13 is formed on the surface of first shell 12, coming under the influence of the crystal structure of first shell 12. Second shell 13 is preferably composed of any of GaAs, GaP, GaN, GaSb, InAs, InP, InN, InSb, AlAs, AlP, AlSb, MN, ZnO, ZnS, ZnSe, and ZnTe.

Nanoparticle core 11, first shell 12 and second shell 13 may contain an unintended impurity, and at least any of a group-II element (Be, Mg, Ca, Sr, Ba), Zn, and Si may intentionally be added as a dopant so long as the concentration thereof is low. The concentration of the dopant above is particularly preferably in a range not lower than 1×10¹⁶ cm⁻³ and not higher than 1×10²¹ cm⁻³, and Mg, Zn, or Si is preferably used as the dopant.

Modifying organic molecule 14 is defined as a compound having a hydrophilic group and a hydrophobic group in a molecule. Examples of modifying organic molecule 14 include a nitrogen-containing functional group, a sulfur-containing functional group, an acidic group, an amide group, a phosphine group, a phosphine oxide group, a hydroxyl group, and the like, such as sodium hexametaphosphate, sodium laurate, sodium dodecyl sulfate, sodium dodecylbenzenesulfonate, triethanolamine lauryl sulfate, lauryl diethanol amide, dodecyltrimethylammonium chloride, trioctylphosphine, and trioctylphosphine oxide. In addition, exemplary modifying organic molecule 14 includes an amine which is a compound having a nonpolar hydrocarbon terminal serving as a hydrophobic group and an amino group serving as a hydrophilic group. Specific examples thereof include butylamine, tert-butylamine, isobutylamine, tri-n-butylamine, tri-isobutylamine, triethylamine, diethylamine, hexylamine, dimethylamine, laurylamine, octylamine, tetradecylamine, tripentylamine, trihexylamine, triheptylamine, trioctylamine, trinonylamine, tridecylamine, triundecylamine, and the like.

It is assumed that modifying organic molecule 14 firmly adheres to the outer surface of second shell 13, because electrical polarity is produced between a heteroatom and a carbon atom. Semiconductor nanoparticle phosphor 10 has good dispersiveness as it is coated with modifying organic molecule 14 and separated from each other. Therefore, handling of semiconductor nanoparticle phosphor 10 is easy.

<Manufacturing Method>

A method of manufacturing the semiconductor nanoparticle phosphor according to the present embodiment is not particularly limited, however, a chemical synthesis method is preferred from a point of view of simplicity and low cost. Here, the chemical synthesis method is a technique for obtaining an intended product by dispersing a plurality of starting substances containing constituent elements of the product in a medium and causing them to react with one another. Such a chemical synthesis method includes a sol-gel process (a colloidal method), a hot soap method, an inverted micelle method, a solvothermal method, a molecule precursor method, a hydrothermal synthesis method, a flux method, and the like.

The hot soap method will be described hereinafter as the method of manufacturing semiconductor nanoparticle phosphor 10 according to the present embodiment. The hot soap method utilizes chemical synthesis of liquid phases and it is suitable for manufacturing nanoparticles composed of a compound semiconductor material.

(1) Synthesis of Nanoparticle Core

Initially, liquid phase synthesis of nanoparticle core 11 is carried out. In an example where nanoparticle core 11 composed of InN is manufactured, a flask or the like is filled with 1-octadecene serving as a solvent, and tris(dimethylamino) indium and hexadecylamine (HDA) are mixed therein. It is noted that HDA serves as modifying organic molecule 14. The liquid mixture above is sufficiently stirred and thereafter caused to react at a synthesis temperature from 180 to 500° C. According to this method, in principle, nanoparticle core 11 grows larger in size as the time for reaction is longer. Therefore, by monitoring the size of nanoparticle core 11 by using photoluminescence, light absorption, dynamic light scattering, or the like, nanoparticle core 11 can be controlled to have a desired size. In this process, a solution containing nanoparticle cores 11 coated with modifying organic molecules 14 is manufactured.

(2) Synthesis of First Shell

A reaction agent which is a raw material for first shell 12 is added to the solution containing nanoparticle cores 11 described above and the resultant solution is heated to chemically bond first shell 12 to the surface of nanoparticle core 11. As first shell 12 grows coming under the influence of the crystal structure of nanoparticle core 11, stress is applied to nanoparticle core 11 from first shell 12 owing to lattice mismatch. In this process, the solution containing nanoparticle cores 11 coated with first shell 12 is manufactured. It is noted that the surface of first shell 12 is coated with modifying organic molecule 14.

(3) Synthesis of Second Shell

A reaction agent which is a raw material for second shell 13 is added to the solution containing nanoparticle cores 11 coated with first shell 12 described above and the resultant solution is heated to chemically bond second shell 13 to the surface of first shell 12. As second shell 13 grows coming under the influence of the crystal structure of nanoparticle core 11 and first shell 12, stress is applied to first shell 12 from second shell 13 owing to lattice mismatch. Here, second shell 13 having such a lattice constant as relaxing the stress applied to nanoparticle core 11 from first shell 12 is formed. As second shell 13 relaxes lattice mismatch between nanoparticle core 11 and first shell 12, semiconductor nanoparticle phosphor 10 including less crystal defects in nanoparticle core 11 as a result of an effect of protection by first shell 12 can be obtained.

The present invention will be described hereinafter in further detail with reference to Examples, however, the present invention is not limited thereto.

### EXAMPLES

### Example 1

In the present example, a semiconductor nanoparticle phosphor absorbing excitation light and emitting red light was fabricated. Specifically, the semiconductor nanoparticle phosphor including a nanoparticle core composed of InN and having an average particle size of 5 nm, a first shell composed of GaN, and a second shell composed of ZnS was fabricated. The lattice constants of InN, GaN and ZnS were determined as 3.545, 3.189 and 3.821, respectively, based on observation with a TEM.

The semiconductor nanoparticle phosphor according to Example 1 was manufactured with the hot soap method. The method of manufacturing Example 1 will be described hereinafter. Initially, the nanoparticle core composed of InN was synthesized by pyrolysis reaction in a 1-octadecene solution, in which tris(dimethylamino) indium and hexadecylamine (HDA) were mixed. Then, this solution was mixed with a 1-octadecene solution, in which tris(dimethylamino) gallium which is a raw material for the first shell and hexadecylamine were mixed, and they were caused to react with each other. In addition, the resultant solution was caused to react with a 1-octadecene solution, in which zinc acetate and sulfur that are raw materials for the second shell and hexadecylamine were mixed, to thereby manufacture the semiconductor nanoparticle phosphor according to Example 1. The semiconductor nanoparticle phosphor according to Example 1 was composed of InN (nanoparticle core)/GaN (first shell)/ZnS (second shell).

In addition, the surface of the semiconductor nanoparticle phosphor is coated with hexadecylamine, and this state is denoted hereinafter as InN/GaN/ZnS/HDA. It is noted that denotation as “A/B” below means “A coated with B.”

The semiconductor nanoparticle phosphor obtained in Example 1 had the structure of the nanoparticle core/the first shell/the second shell. As the first shell is smaller in the lattice constant than the nanoparticle core, compressive stress is applied to the nanoparticle core from the first shell. In order to relax the compressive stress, the first shell was coated with the second shell greater in the lattice constant than the nanoparticle core. The semiconductor nanoparticle phosphor thus fabricated according to Example 1 had high crystallinity and high light emission efficiency. In addition, as the surface of the second shell was coated with the modifying organic molecule, aggregation of the semiconductor nanoparticle phosphors was less likely and the semiconductor nanoparticle phosphor had a uniform size and high dispersiveness.

A blue light-emitting device composed of a group-XIII nitride may be used as an excitation light source for the semiconductor nanoparticle phosphor according to Example 1, and in particular, it can efficiently absorb light emission at 405 nm, which is high in external quantum efficiency. In addition, as the average particle size of the nanoparticle core composed of InN is adjusted such that a light emission wavelength attains to 620 nm, red light emission is exhibited. The average particle size of the semiconductor nanoparticle phosphor according to Example 1 is controlled by the modifying organic molecule, and the obtained semiconductor nanoparticle phosphor was measured with X-ray diffraction. Consequently, the average particle size (diameter) of the semiconductor nanoparticle phosphor estimated based on a spectrum half width was 5 nm using the equation of Scherrer (Equation (2)), and the quantum size effect was exhibited and hence the light emission efficiency was improved.

B=λ/cos θ·R Equation (2)

where B represents an X-ray half width [deg], λ represents a wavelength of the X-ray [nm], θ represents a Bragg angle [deg], and R represents an average particle size [nm].

The results above were summarized in Table 1. Examples below were also similarly summarized in Table 1.

TABLE 1

| | Nanoparticle Core | First Shell | Second Shell | | Average | Excitation Light | Light Emission |
|---|---|---|---|---|---|---|---|
| | (Material/ | (Material/ | (Material/ | Third Shell | Particle Size | Wavelength | Wavelength |
| | Lattice Constant) | Lattice Constant) | Lattice Constant) | (Material) | (nm) | (nm) | (nm) |
| Example 1 | InN/3.545 | GaN/3.189 | ZnS/3.821 | — | 5 | 405 | 620 (Red) |
| Example 2 | InN/3.545 | ZnS/3.821 | AlN/3.112 | — | 4 | 405 | 520 (Green) |
| Example 3 | InN/3.545 | ZnS/3.821 | ZnO/3.250 | SiO₂ | 3 | 405 | 470 (Blue) |
| Example 4 | InP/5.870 | GaN/4.510 | ZnS/5.406 | — | 3 | 405 | 650 (Red) |
| Example 5 | In_{0.2}Ga_{0.8}N/3.26 | GaN/3.189 | ZnS/3.821 | — | 5 | 405 | 460 (Blue) |
| Example 6 | In_{0.7}Ga_{0.3}P/5.77 | AlN/4.401 | ZnS/5.406 | — | 3 | 405 | 600 (Red) |
| Comparative | InN/3.545 | GaN/3.189 | — | — | 5 | 405 | 620 (Red) |
| Example 1 | | | | | | | |

### Example 2

In Example 2, a semiconductor nanoparticle phosphor absorbing excitation light and emitting green light was fabricated. Specifically, the semiconductor nanoparticle phosphor including a nanoparticle core composed of InN and having an average particle size of 4 nm, a first shell composed of ZnS, and a second shell composed of AlN was fabricated. The lattice constants of InN, ZnS and AlN were determined as 3.545, 3.821 and 3.112, respectively, based on observation with a TEM.

The semiconductor nanoparticle phosphor according to Example 2 was manufactured with the hot soap method. The method of manufacturing Example 2 will be described hereinafter. Initially, the nanoparticle core composed of InN was synthesized by pyrolysis reaction in a 1-octadecene solution, in which tris(dimethylamino) indium and hexadecylamine (HDA) were mixed. Then, a zinc acetate and sulfur solution was caused to react, to form the first shell on the surface of the nanoparticle core. In addition, by causing tris(dimethylamino) aluminum to react, the second shell was formed on the surface of the first shell. The semiconductor nanoparticle phosphor thus fabricated according to Example 2 had the structure of InN/ZnS/AlN/HDA.

The semiconductor nanoparticle phosphor obtained in Example 2 had the structure of the nanoparticle core/the first shell/the second shell. As the first shell is greater in the lattice constant than the nanoparticle core, tensile stress is applied to the nanoparticle core from the first shell. In order to relax the tensile stress, the first shell was coated with the second shell smaller in the lattice constant than the nanoparticle core. The semiconductor nanoparticle phosphor thus fabricated according to Example 2 had high crystallinity and high light emission efficiency. In addition, as the surface of the second shell was coated with the modifying organic molecule, aggregation of the semiconductor nanoparticle phosphors was less likely and the semiconductor nanoparticle phosphor had a uniform size and high dispersiveness.

A blue light-emitting device composed of a group-XIII nitride may be used as an excitation light source for the semiconductor nanoparticle phosphor according to Example 2, and in particular, it can efficiently absorb light emission at 405 nm, which is high in external quantum efficiency. In addition, as the average particle size of the nanoparticle core is adjusted such that a light emission wavelength attains to 520 nm, green light emission is exhibited. The average particle size of the semiconductor nanoparticle phosphor according to Example 2 is controlled by the modifying organic molecule, and the obtained semiconductor nanoparticle phosphor was measured with X-ray diffraction. Consequently, the average particle size (diameter) of the semiconductor nanoparticle phosphor estimated based on a spectrum half width was 4 nm, and the quantum size effect WM exhibited and hence the light emission efficiency was improved.

### Example 3

In Example 3, a semiconductor nanoparticle phosphor absorbing excitation light and emitting blue light was fabricated. Specifically, the semiconductor nanoparticle phosphor including a nanoparticle core composed of InN and having an average particle size of 3 nm, a first shell composed of ZnS, a second shell composed of ZnO, and a third shell composed of SiO₂ was fabricated. The lattice constants of InN, ZnS and ZnO were determined as 3.545, 3.821 and 3.250, respectively, based on observation with a TEM.

The semiconductor nanoparticle phosphor according to Example 3 was manufactured with the hot soap method. The method of manufacturing Example 3 will be described hereinafter. The nanoparticle core composed of InN was synthesized by pyrolysis reaction in a 1-octadecene solution, in which tris(dimethylamino) indium and hexadecylamine (HDA) were mixed. Then, an aqueous solution composed of zinc acetate, ethanol and water was caused to react, to form the first shell and the second shell. In addition, the third shell composed of SiO₂ was formed as an outer shell, by causing tetraethoxysilane, methanol and the aqueous solution above to react with one another through the sol-gel process. The semiconductor nanoparticle phosphor thus fabricated according to Example 3 had the structure of InN/ZnS/ZnO/SiO₂/HDA.

The semiconductor nanoparticle phosphor obtained in Example 3 had the structure of the nanoparticle core/the first shell/the second shell/the third shell. As the first shell is greater in the lattice constant than the nanoparticle core, tensile stress is applied to the nanoparticle core from the first shell. In order to relax the tensile stress, the first shell was coated with the second shell smaller in the lattice constant than the nanoparticle core. The semiconductor nanoparticle phosphor thus fabricated according to Example 3 had high crystallinity and high light emission efficiency. In addition, as the surface of the third shell was coated with the modifying organic molecule, aggregation of the semiconductor nanoparticle phosphors was less likely and the semiconductor nanoparticle phosphor had a uniform size and high dispersiveness. Moreover, as the third shell composed of SiO₂ was provided, the surface of the semiconductor nanoparticle phosphor could securely be protected.

A blue light-emitting device composed of a group-XIII nitride may be used as an excitation light source for the semiconductor nanoparticle phosphor according to Example 3, and in particular, it can efficiently absorb light emission at 405 nm, which is high in external quantum efficiency. In addition, as the average particle size of the nanoparticle core is adjusted such that a light emission wavelength attains to 470 nm, blue light emission is exhibited. The average particle size of the semiconductor nanoparticle phosphor according to Example 3 is controlled by the modifying organic molecule, and the obtained semiconductor nanoparticle phosphor was measured with X-ray diffraction. Consequently, the average particle size (diameter) of the semiconductor nanoparticle phosphor estimated based on a spectrum half width was 3 nm, and the quantum size effect was exhibited and hence the light emission efficiency was improved.

### Example 4

In Example 4, a semiconductor nanoparticle phosphor absorbing excitation light and emitting red light was fabricated. Specifically, the semiconductor nanoparticle phosphor including a nanoparticle core composed of InP and having an average particle size of 3 nm, a first shell composed of GaN, and a second shell composed of ZnS was fabricated. The lattice constants of InP, GaN and ZnS were determined as 5.870, 4.510 and 5.406, respectively, based on observation with a TEM.

The semiconductor nanoparticle phosphor according to Example 4 was manufactured with the hot soap method. The method of manufacturing Example 4 will be described hereinafter. Initially, the nanoparticle core composed of InP was synthesized by causing reaction in a 1-octadecene solution, in which indium trichloride and tris(trimethylsilyl phosphine) and hexadecylamine (HDA) were mixed. Then, this solution was caused to react with a 1-octadecene solution, in which tris(dimethylamino) gallium which is a raw material for the first shell and hexadecylamine were mixed, to thereby form the first shell. Then, this solution was caused to react with a 1-octadecene solution, in which zinc acetate and sulfur and hexadecylamine were mixed, to thereby form the second shell. The semiconductor nanoparticle phosphor thus fabricated according to Example 4 had the structure of InP/GaN/ZnS/HDA.

The semiconductor nanoparticle phosphor obtained in Example 4 had the structure of the nanoparticle core/the first shell/the second shell. As the first shell is smaller in the lattice constant than the nanoparticle core, compressive stress is applied to the nanoparticle core from the first shell. In order to relax the compressive stress, the first shell was coated with the second shell having the lattice constant intermediate between the lattice constant of the nanoparticle core and the lattice constant of the first shell. The semiconductor nanoparticle phosphor thus fabricated according to Example 4 had high crystallinity and high light emission efficiency. In addition, as the surface of the second shell was coated with the modifying organic molecule, aggregation of the semiconductor nanoparticle phosphors was less likely and the semiconductor nanoparticle phosphor had a uniform size and high dispersiveness.

A blue light-emitting device composed of a group-XIII nitride may be used as an excitation light source for the semiconductor nanoparticle phosphor according to Example 4, and in particular, it can efficiently absorb light emission at 405 nm, which is high in external quantum efficiency. In addition, as the average particle size of the nanoparticle core is adjusted such that a light emission wavelength attains to 650 nm, red light emission is exhibited. The average particle size of the semiconductor nanoparticle phosphor according to Example 4 is controlled by the modifying organic molecule, and the obtained semiconductor nano phosphor was measured with X-ray diffraction. Consequently, the average particle size (diameter) of the semiconductor nanoparticle phosphor estimated based on a spectrum half width was 3 nm, and the quantum size effect was exhibited and hence the light emission efficiency was improved.

### Example 5

In Example 5, a semiconductor nanoparticle phosphor absorbing excitation light and emitting blue light was fabricated. Specifically, the semiconductor nanoparticle phosphor including a nanoparticle core composed of In_{0.2}Ga_{0.8}N and having an average particle size of 5 nm, a first shell composed of GaN, and a second shell composed of ZnS was fabricated. The lattice constants of In_{0.2}Ga_{0.8}N, GaN and ZnS were determined as 3.26, 3.189 and 3.821, respectively, based on observation with a TEM.

The semiconductor nanoparticle phosphor according to Example 5 was manufactured with the hot soap method. The method of manufacturing Example 5 will be described hereinafter. Initially, the nanoparticle core composed of In_{0.2}Ga_{0.8}N was synthesized by causing pyrolysis reaction in a 1-octadecene solution, in which tris(dimethylamino) indium, tris(dimethylamino) gallium and hexadecylamine (RDA) were mixed. Then, this solution was caused to react with a tris(dimethylamino) gallium solution that is a raw material for the first shell, to thereby form the first shell. Then, a zinc acetate and sulfur solution that is a raw material for the second shell was caused to react, to thereby form the second shell. The semiconductor nanoparticle phosphor thus fabricated according to Example 5 had the structure of In_{0.2}Ga_{0.8}N/GaN/ZnS/HDA.

The semiconductor nanoparticle phosphor obtained in Example 5 had the structure of the nanoparticle core/the first shell/the second shell. As the first shell is smaller in the lattice constant than the nanoparticle core, compressive stress is applied to the nanoparticle core from the first shell. In order to relax the compressive stress, the first shell was coated with the second shell greater in the lattice constant than the nanoparticle core. The semiconductor nanoparticle phosphor thus fabricated according to Example 5 had high crystallinity and high light emission efficiency. In addition, as the surface of the second shell was coated with the modifying organic molecule, aggregation of the semiconductor nanoparticle phosphors was less likely and the semiconductor nanoparticle phosphor had a uniform size and high dispersiveness.

A blue light-emitting device composed of a group-XIII nitride may be used as an excitation light source for the semiconductor nanoparticle phosphor according to Example 5, and in particular, it can efficiently absorb light emission at 405 nm, which is high in external quantum efficiency. In addition, as the average particle size of the nanoparticle core is adjusted such that a light emission wavelength attains to 460 nm, blue light emission is exhibited. The average particle size of the semiconductor nanoparticle phosphor according to Example 5 is controlled by the modifying organic molecule, and the obtained semiconductor nanoparticle phosphor was measured with X-ray diffraction. Consequently, the average particle size (diameter) of the semiconductor nanoparticle phosphor estimated based on a spectrum half width was 5 nm, and the quantum size effect was exhibited and hence the light emission efficiency was improved.

### Example 6

In Example 6, a semiconductor nanoparticle phosphor absorbing excitation light and emitting red light was fabricated. Specifically, the semiconductor nanoparticle phosphor including a nanoparticle core composed of In_{0.7}Ga_{0.3}P and having an average particle size of 3 nm, a first shell composed of AlN, and a second shell composed of ZnS was fabricated. The lattice constants of In_{0.7}Ga_{0.3}P, AlN and ZnS were determined as 5.77, 4.401 and 5.406, respectively, based on observation with a TEM.

The semiconductor nanoparticle phosphor according to Example 6 was manufactured with the hot soap method. The method of manufacturing Example 6 will be described hereinafter. Initially, the In_{0.7}Ga_{0.3}P nanoparticle core was synthesized by causing reaction in a 1-octadecene solution, in which indium trichloride, gallium trichloride, tris(trimethylsilyl phosphine), and hexadecylamine (HDA) were mixed. Then, this solution was caused to react with a 1-octadecene solution, in which tris(dimethylamino) aluminum that is a raw material for the first shell and hexadecylamine were mixed, to thereby form the first shell. Then, a 1-octadecene solution, in which zinc acetate and sulfur that are raw materials for the second shell and hexadecylamine were mixed, was caused to react, to thereby form the second shell. The semiconductor nanoparticle phosphor thus fabricated according to Example 6 had the structure of In_{0.7}Ga_{0.3}P/AlN/ZnS/HDA.

The semiconductor nanoparticle phosphor obtained in Example 6 had the structure of the nanoparticle core/the first shell/the second shell. As the first shell is smaller in the lattice constant than the nanoparticle core, compressive stress is applied to the nanoparticle core from the first shell. In order to relax the compressive stress, the first shell was coated with the second shell having the lattice constant intermediate between the lattice constant of the nanoparticle core and the lattice constant of the first shell. The semiconductor nanoparticle phosphor thus fabricated according to Example 6 had high crystallinity and high light emission efficiency. In addition, as the surface of the second shell was coated with the modifying organic molecule, aggregation of the semiconductor nanoparticle phosphors was less likely and the semiconductor nanoparticle phosphor had a uniform size and high dispersiveness.

As the nanoparticle core used in Example 6 is composed of a group-XIII indium gallium mixed crystal semiconductor, a light emission wavelength of the semiconductor nanoparticle phosphor according to Example 6 can be adjusted based on the mixed crystal ratio between indium and gallium and the average particle size. Therefore, the light emission wavelength of the semiconductor nanoparticle phosphor according to Example 6 was readily controlled. In addition, as the surface of the second shell was coated with the modifying organic molecule, aggregation of the semiconductor nanoparticle phosphors was less likely and the semiconductor nanoparticle phosphor had a uniform size and high dispersiveness.

A blue light-emitting device composed of a group-XIII nitride may be used as an excitation light source for the semiconductor nanoparticle phosphor according to Example 6, and in particular, it can efficiently absorb light emission at 405 nm, which is high in external quantum efficiency. In addition, as the average particle size of the nanoparticle core is adjusted such that a light emission wavelength attains to 600 nm, red light emission is exhibited. The average particle size of the semiconductor nanoparticle phosphor according to Example 6 is controlled by the modifying organic molecule, and X-ray diffraction measurement of the obtained semiconductor nanoparticle phosphor was conducted. Consequently, the average particle size (diameter) of the semiconductor nanoparticle phosphor estimated based on a spectrum half width was 3 nm, and the quantum size effect was exhibited and hence the light emission efficiency was improved.

### Comparative Example 1

A phosphor having a two-layered structure of a nanoparticle core composed of InN and having an average particle size of 5 nm and a shell composed of GaN for coating the nanoparticle core was fabricated. FIG. 2 is a schematic diagram of the phosphor manufactured in Comparative Example 1. Comparative Example 1 will be described hereinafter with reference to FIG. 2.

A nanoparticle core 31 composed of InN was synthesized by causing pyrolysis reaction in a 1-octadecene solution, in which tris(dimethylamino) indium and hexadecylamine (HDA) were mixed. Then, this solution was caused to react with a 1-octadecene solution, in which tris(dimethylamino) gallium that is a raw material for a shell 32 and hexadecylamine were mixed, to thereby form shell 32. A semiconductor nanoparticle phosphor 30 having a structure of InN/GaN/HDA was thus obtained.

According to Comparative Example 1, the semiconductor nanoparticle phosphor containing indium nitride having the core/shell structure can be obtained. As the shell is smaller in the lattice constant than the nanoparticle core, compressive stress is applied to the nanoparticle core from the shell. Therefore, the semiconductor nanoparticle phosphor was low in crystallinity and light emission efficiency. It is noted that nanoparticle core 31 absorbed light emission at 405 nm, and semiconductor nanoparticle phosphor 30 had a light emission wavelength of 620 nm and exhibited red light emission.

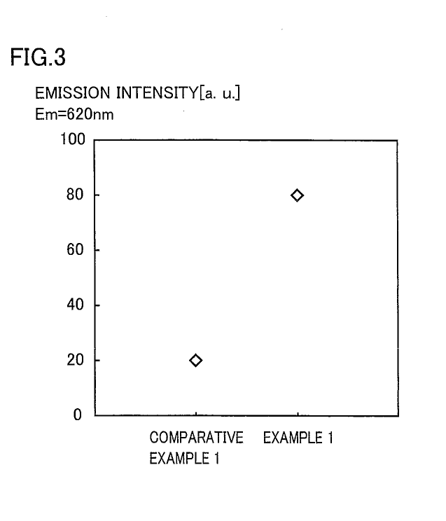

FIG. 3 is a graph showing light emission characteristics of the semiconductor nanoparticle phosphors in Example 1 and Comparative Example 1. The ordinate in FIG. 3 represents intensity of red light emission (at a wavelength of 620 nm) of each semiconductor nanoparticle phosphor (unit: arbitrary unit).

As can clearly be seen in FIG. 3, the semiconductor nanoparticle phosphor according to Example 1 is higher in emission intensity than the semiconductor nanoparticle phosphor according to Comparative Example 1.

Although the present invention has been described and illustrated in detail, it is clearly understood that the same is by way of illustration and example only and is not to be taken by way of limitation, the scope of the present invention being interpreted by the terms of the appended claims.

The present invention provides a semiconductor nanoparticle phosphor excellent in light emission efficiency and dispersiveness.

What is claimed is:

1. A semiconductor nanoparticle phosphor, comprising:
a nanoparticle core composed of a group-XIII and -XV semiconductor;
a first shell for coating said nanoparticle core; and
a second shell for coating said first shell, and
a difference in a lattice constant between said nanoparticle core and said second shell being smaller than a difference in the lattice constant between said nanoparticle core and said first shell, or
said first shell being smaller in the lattice constant than said nanoparticle core and said second shell being greater in the lattice constant than said nanoparticle core, or
said first shell being greater in the lattice constant than said nanoparticle core and said second shell being smaller in the lattice constant than said nanoparticle core.

2. The semiconductor nanoparticle phosphor according to claim 1, wherein
the respective lattice constants of said nanoparticle core, said first shell and said second shell satisfy relation, in terms of magnitude, of
said first shell <said nanoparticle core <said second shell, or
said second shell <said nanoparticle core <said first shell.

3. The semiconductor nanoparticle phosphor according to claim 1, wherein
the respective lattice constants of said nanoparticle core, said first shell and said second shell satisfy relation, in terms of magnitude, of
said nanoparticle core <said second shell <said first shell, or
said first shell <said second shell <said nanoparticle core.

4. The semiconductor nanoparticle phosphor according to claim 1, wherein
said nanoparticle core is made of a group-XIII nitride semiconductor.

5. The semiconductor nanoparticle phosphor according to claim 1, wherein
said nanoparticle core is made of indium nitride.

6. The semiconductor nanoparticle phosphor according to claim 1, wherein
said nanoparticle core is made of a group-XIII mixed crystal nitride semiconductor.

7. The semiconductor nanoparticle phosphor according to claim 1, wherein
said nanoparticle core is made of indium gallium nitride.

8. The semiconductor nanoparticle phosphor according to claim 1, wherein
said nanoparticle core has an average particle size not greater than twice as large as a Bohr radius.

9. The semiconductor nanoparticle phosphor according to claim 1, further comprising a plurality of shells on an outer side of said second shell, and having a stack structure including three or more layers from said first shell to an outermost shell.

10. The semiconductor nanoparticle phosphor according to claim 9, wherein
an outer surface of said second shell or said outermost shell is bonded to or coated with a modifying organic molecule.
